(19) United States
(12) Patent Application Publication
(10) Pub. No.: US 2019/0247784 A1
(43) Pub. Date: Aug. 15, 2019

(54) THERMALLY REARRANGED POLYMER GAS SEPARATION MEMBRANE HAVING FLUORINATED CROSS-LINKED STRUCTURE, AND PREPARATION METHOD THEREFOR

(71) Applicant: INDUSTRY-UNIVERSITY COOPERATION FOUNDATION HANYANG UNIVERSITY, Seoul (KR)

(72) Inventors: Young Moo LEE, Seoul (KR); Jong Geun SEONG, Seoul (KR); Hye Jin JO, Nonsan-s (KR); Yu Seong DO, Cheonan-si (KR); Jongmyeong LEE, Seoul (KR); Won Hee LEE, Seoul (KR)

(73) Assignee: INDUSTRY-UNIVERSITY COOPERATION FOUNDATION HANYANG UNIVERSITY, Seou (KR)

(21) Appl. No.: 16/319,010

(22) PCT Filed: Jul. 18, 2017
(86) PCT No.: PCT/KR2017/007715

§ 371 Date: Jan. 18, 2019

(30) Foreign Application Priority Data
Jul. 19, 2016 (KR) 10-2016-0091348

(51) Int. Cl. B01D 53/22; B01D 69/06; B01D 69/08; B01D 63/10; B01D 71/64; B01D 67/00; C01B 23/00; C10L 3/10; C08G 73/10; C08J 5/18

(52) U.S. Cl. CPC B01D 53/228; C08J 2379/08; B01D 69/08; B01D 63/10; B01D 71/64; B01D 67/0013; B01D 67/0093; B01D 67/0083; C01B 23/0047; C10L 3/101; C08G 73/1067; C08G 73/1003; C08J 5/18; C01B 2210/0012; C01B 2210/0031; C01B 2210/007; C10L 2290/548; B01D 69/06

(57) ABSTRACT

The present disclosure relates to a cross-linked thermally rearranged polymer membrane and a method for preparing the same. The cross-linked thermally rearranged polymer membrane prepared according to the present disclosure has fluorine atoms distributed in a cross-linked thermally rearranged polymer membrane so as to have a concentration gradient from the surface and is formed into a three-layer structure consisting of a fluorine deposition layer, a transition layer and a thermally rearranged polymer base layer, thereby having remarkably increased selectivity as compared to the existing commercialized gas separation membrane and, particularly, enabling helium to be separated with high purity and recovery rate from a natural gas well, etc. even with a small membrane area, and thus being commercializable.

### TECHNICAL FIELD

The present disclosure relates to a cross-linked thermally rearranged polymer membrane and a method for preparing the same, more particularly to a thermally rearranged polymer membrane having a cross-linked structure directly fluorinated such that fluorine atoms are distributed in the membrane so as to have a concentration gradient and being formed into a three-layer structure and application thereof for gas separation.

### BACKGROUND ART

Recently, membrane-based gas separation is drawing a lot of attentions as a rapidly emerging important separation technology. Gas separation using membranes has many advantages over the traditional separation process in that higher-level process utility can be provided despite low energy consumption and operation cost. In particular, basic researches have been conducted a lot using organic polymer membranes since the 1980s. However, the traditional polymer materials exhibit relatively low material transport rate due to the effective packing of polymer chains with few micropores. Therefore, there have been various attempts to improve gas permeability or selectivity by treating the gas separation membranes based on the traditional polymer materials with fluorine. However, commercialization has not been achieved yet due to the limitation in selectivity, etc. (patent documents 1 and 2).

Recently, polymers having a high level of free volume known as microporous organic polymers are considered one of the most promising candidates in a separation process due to their adsorption ability and improved diffusion capacity for small gas molecules. Based on the fact that the microporous polymer based on the rigid ladder structure having a distorted region hindering the effective packing of polymer chains exhibits relatively high gas permeability and selectivity, various researches are being conducted for development of organic polymers that can be used as gas separation membranes.

Among them, attempts to use rigid glassy wholly aromatic organic polymers with superior thermal, mechanical and chemical properties such as polybenzoxazole, polybenzimidazole, polybenzthiazole, etc. as gas separation membranes are drawing attentions. However, because these organic polymers are hardly soluble in most common organic solvents, it is difficult to prepare a membrane through the simple and practical solvent casting method. Therefore, a method of preparing a precursor membrane such as hydroxypolyimide by solvent casting and then preparing a gas separation membrane with a repeat unit such as polybenzoxazole, etc. introduced into the polymer chain through thermal rearrangement has been developed. However, the selectivity is still unsatisfactory for commercialization and the gas that may be separated is also restricted (patent documents 3 and 4).

The inventors of the present disclosure have noticed that, if a cross-linked thermally rearranged polymer membrane and having a repeat unit such as polybenzoxazole, etc. introduced into the polymer chain can be directly fluorinated such that fluorine atoms are distributed to have a concentration gradient in the membrane, selectivity can be remarkably improved as compared to the existing commercialized gas separation membrane and commercialization thereof will be possible, and have completed the present disclosure.

### REFERENCES OF RELATED ART

### Patent Documents

Patent document 1: US Patent No. 4,657,564.

Patent document 2: US Patent No. 4,828,585.

Patent document 3: Korean Patent Registration No. 10-0932765.

Patent document 4: Korean Patent Publication No. 10-2006-0085845.

### DISCLOSURE

### Technical Problem

The present disclosure has been made in consideration of the aforesaid problems and is directed to providing a cross-linked thermally rearranged polymer membrane, wherein fluorine atoms are distributed in a thermally rearranged polymer membrane having a cross-linked structure with very high selectivity so as to have a concentration gradient and which is formed to have a three-layer structure, and a method for preparing the same.

### Technical Solution

The present disclosure provides a cross-linked thermally rearranged polymer membrane, having a repeat unit represented by <Chemical Formula 1> or <Chemical Formula 2>, wherein the membrane is formed into a fluorine deposition layer, a transition layer and a thermally rearranged polymer base layer as fluorine atoms are distributed to have a concentration gradient from the surface:

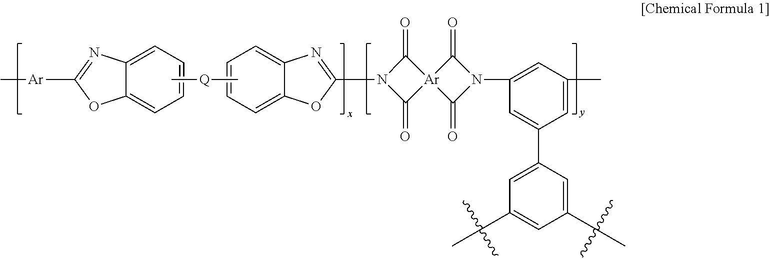

wherein

Ar is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,

Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group, and

x and y are the molar ratios of the corresponding repeat units, wherein both x and y are greater than 0 and x+y=1

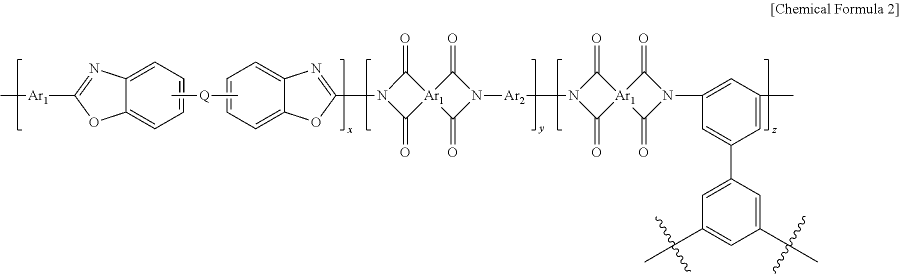

wherein

Ar₁ is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,

Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group,

Ar₂ is an aromatic ring group selected from a substituted or unsubstituted divalent C₆-C₂₄ arylene group and a substituted or unsubstituted divalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{c}, (1≤q≤10), C(CH₃)₂, C(CF₃)₂ or CO—NH, and

x, y and z are the molar ratios of the corresponding repeat units, wherein all of x, y and z are greater than 0 and x+y+z=1.

The gas separation membrane is a flat-sheet membrane, a hollow fiber membrane or a spiral wound membrane.

The gas separation membrane is for separation of a mixture gas of He/N₂, He/CH₄, He/CO₂, He/H₂, H₂/CO₂, H₂/N₂, H₂/CH₄, CO₂/CH₄, O₂/N₂ or N₂/CH₄.

The present disclosure also provides a method for preparing the cross-linked thermally rearranged polymer membrane produced by direct fluorination, having a repeat unit represented by <Chemical Formula 1> or <Chemical Formula 2>, which includes: I) a step of synthesizing an o-hydroxypolyimide copolymer having carboxylic acid; II) a step of preparing a membrane by casting a polymer solution in which the copolymer is dissolved in an organic solvent or by spinning a dope solution containing the copolymer, an organic solvent and an additive; III) a step of obtaining a membrane having a cross-linked structure by thermally cross-linking the membrane; IV) a step of thermally rearranging the membrane having a cross-linked structure; and V) a step of directly fluorinating the cross-linked thermally rearranged polymer membrane.

The o-hydroxypolyimide copolymer having carboxylic acid is synthesized by azeotropic thermal imidization after obtaining a polyamic acid solution by reacting an acid dianhydride, o-hydroxydiamine and 3,5-diaminobenzoic acid as a comonomer.

An aromatic diamine not containing a carboxylic acid group is further used as a comonomer.

The acid dianhydride is represented by <General Formula 1> or <General Formula 2>:

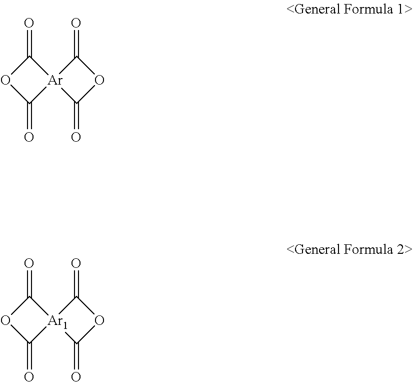

wherein Ar is the same as defined in <Chemical Formula 1> and Ar₁ is the same as defined in <Chemical Formula 2>.

The o-hydroxydiamine is represented by <General Formula 3>:

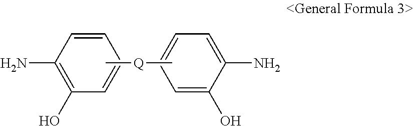

wherein Q is the same as defined in <Chemical Formula 1> or <Chemical Formula 2>.

The aromatic diamine not containing a carboxylic acid group is represented by <General Formula 4>:

H₂N—Ar₂—NH₂ <General Formula 4>

wherein Arₑ is the same as defined in <Chemical Formula 2>.

The azeotropic thermal imidization is conducted by adding toluene or xylene to the polyamic acid solution and performing imidization at 180-200° C. for 6-24 hours under stirring.

The organic solvent is one selected from a group consisting of N-methylpyrrolidone (NMP), dimethylacetamide (DMAc), dimethylformamide (DMF), dimethyl sulfoxide (DMSO), γ-butyrolactam (GBL), propionic acid (PA) and a mixture thereof.

The organic solvent is a mixture of N-methylpyrrolidone (NMP) and propionic acid (PA) (NMP:PA=99:1-50:50 mol %).

The additive is one selected from a group consisting of acetic acid, tetrahydrofuran, acetone, 1,4-dioxane, trichloroethane, ethylene glycol, methanol, ethanol, isopropanol, 2-methyl-1-butanol, 2-methyl-2-butanol, 2-pentanol, glycerol, polyethylene glycol, polyethylene oxide and a mixture thereof.

The polymer solution has a concentration of 10-30 wt %.

The dope solution contains 10-30 wt % of the copolymer, 20-80 wt % of the organic solvent and 5-30 wt % of the additive.

The dope solution has a viscosity of 1,000-100,000 cp.

The thermal cross-linking is conducted by heating the membrane obtained in the step II) to 250-350° C. at a heating rate of 1-20° C./min under an inert gas atmosphere and maintaining the temperature for 0.1-6 hour(s).

The thermal rearrangement is conducted by heating the membrane having a cross-linked structure obtained in the step III) to 350-450° C. at a heating rate of 1-20° C./min under an inert gas atmosphere and maintaining the temperature for 0.1-6 hour(s).

The direct fluorination in the step V) is conducted using a mixture gas containing 1 ppm to 1 vol % of fluorine gas.

The mixture gas contains fluorine gas and nitrogen, argon or helium as a dilution gas.

The direct fluorination is conducted for 1 minute to 24 hours.

### ADVANTAGEOUS EFFECTS

A cross-linked thermally rearranged polymer membrane prepared according to the present disclosure has fluorine atoms distributed in a thermally rearranged polymer membrane having a cross-linked structure so as to have a concentration gradient from the surface and is formed into a three-layer structure consisting of a fluorine deposition layer, a transition layer and a thermally rearranged polymer base layer, thereby having remarkably increased selectivity as compared to the existing commercialized gas separation membrane and, particularly, enabling helium to be separated with high purity and recovery rate from a natural gas well, etc. even with a small membrane area, and thus being commercializable.

### BRIEF DESCRIPTION OF DRAWINGS

FIG. 1 shows a cross-sectional image of the cross-linked thermally rearranged polymer membrane prepared in Example 8 according to the present disclosure obtained by focused ion beam-scanning electron microscopy-energy-dispersive X-ray analysis (FIB-SEM-EDX).

FIG. 2 shows the change in the S parameter [a value proportional to the fractional free volume (FFV)] up to 2 μm from the surface of the cross-linked thermally rearranged polymer membranes prepared in Examples 1-3, 5 and 6 according to the present disclosure and Comparative Example 2 (PTFE membrane), determined by Doppler broadening energy spectroscopy (DBES) [Example 1 (●), Example 2 ▪), Example 3 (▴), Example 5 (♦), Example 6 (★), Comparative Example 2 (⋄)].

FIG. 3 shows the change in T₃ (a value proportional to the pore size at the waist portion of the hourglass-shaped pore distribution of the thermally rearranged polymer) and pore radius up to 1 μm from the surface of the cross-linked thermally rearranged polymer membranes prepared in Examples 1-3, 5 and 6 according to the present disclosure and Comparative Example 1, determined by slow beam positron annihilation lifetime spectroscopy (SB-PALS) [Example 1 (●), Example 2 (▪), Example 3 (▴), Example 5 (♦), Example 6 (★), Comparative Example 1 (⋄)].

FIG. 4 shows the natural gas separation performance (He/CH₄, H₂/CH₄) of the cross-linked thermally rearranged polymer membranes prepared in Examples 1-3 according to the present disclosure and an unfluorinated cross-linked thermally rearranged polymer membrane prepared in Comparative Example 1 together with the 2008 Robeson upper bounds.

FIG. 5 shows the natural gas separation performance (N₂/CH₄, CO₂/CH₄) of the cross-linked thermally rearranged polymer membranes prepared in Examples 1-3 according to the present disclosure and an unfluorinated cross-linked thermally rearranged polymer membrane prepared in Comparative Example 1 together with the 2008 Robeson upper bounds.

FIG. 6 shows the air separation performance (O₂/N₂) of cross-linked thermally rearranged polymer membranes prepared in Examples 1-3 according to the present disclosure and an unfluorinated cross-linked thermally rearranged polymer membrane prepared in Comparative Example 1 together with the 2008 Robeson upper bounds.

FIG. 7 shows the hydrogen separation performance (H₂/CO₂, H₂/N₂) of cross-linked thermally rearranged polymer membranes prepared in Examples 1-3 according to the present disclosure and an unfluorinated cross-linked thermally rearranged polymer membrane prepared in Comparative Example 1 together with the 2008 Robeson upper bounds.

FIG. 8 shows scanning electron microscopy (SEM) images showing the morphology inside the cross-linked thermally rearranged polymer hollow fiber membrane prepared in Example 13 according to the present disclosure (a) and an unfluorinated cross-linked thermally rearranged polymer hollow fiber membrane prepared in Comparative Example 3 (b).

FIG. 9 shows images of the cross-linked thermally rearranged polymer hollow fiber membrane prepared in Example 15 according to the present disclosure (a) and an unfluorinated cross-linked thermally rearranged polymer hollow fiber membrane prepared in Comparative Example 4 (b) obtained with an electron probe X-ray microanalyzer (EPMA).

FIG. 10 shows the change in the S parameter [a value proportional to the fractional free volume (FFV)] up to 1 μm from the surface of the cross-linked thermally rearranged polymer membrane prepared in Example 13 according to the present disclosure and Comparative Example 2, determined by Doppler broadening energy spectroscopy (DBES).

FIG. 11 shows the change in T₃ (a value proportional to the pore size at the waist portion of the hourglass-shaped pore distribution of the thermally rearranged polymer) and pore radius up to 1 μm from the surface of a cross-linked thermally rearranged polymer membrane prepared in Example 13 according to the present disclosure and Comparative Example 2, determined by slow beam positron annihilation lifetime spectroscopy (SB-PALS).

FIG. 12 shows the recovery rate and purity of a permeate from a mixture gas (1% helium/99% methane) feed depending on stage-cut when hollow fiber membranes prepared in Example 16 according to the present disclosure and Comparative Example 3 were used [Example 16: red, Comparative Example 3: black].

### BEST MODE

Hereinafter, a cross-linked thermally rearranged polymer membrane and a method for preparing the same according to the present disclosure are described in detail referring to the attached drawings.

First, the present disclosure provides cross-linked thermally rearranged polymer membrane, having a repeat unit represented by <Chemical Formula 1> or <Chemical Formula 2>, wherein the membrane is formed into a fluorine deposition layer, a transition layer and a thermally rearranged polymer base layer as fluorine atoms are distributed to have a concentration gradient from the surface:

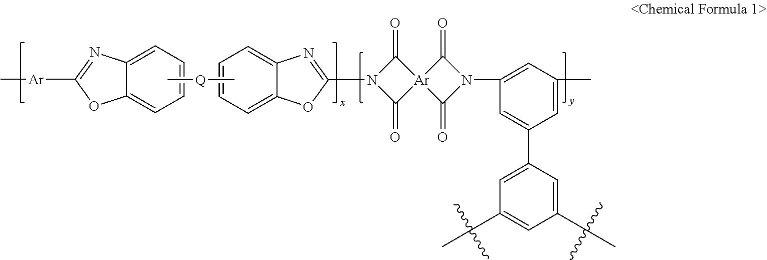

wherein

Ar is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,

Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group, and

x and y are the molar ratios of the corresponding repeat units, wherein both x and y are greater than 0 and x+y=1

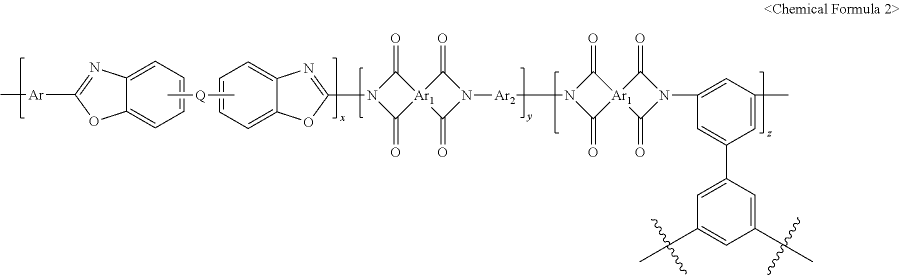

wherein

Ar₁ is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,

Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group,

Ar₂ is an aromatic ring group selected from a substituted or unsubstituted divalent C₆-C₂₄ arylene group and a substituted or unsubstituted divalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH, and

x, y and z are the molar ratios of the corresponding repeat units, wherein all of x, y and z are greater than 0 and x+y+z=1.

The cross-linked thermally rearranged polymer membrane according to the present disclosure may be in the form of a flat-sheet membrane, a hollow fiber membrane or a spiral wound membrane. Indeed, as will be described later in the examples, a flat-sheet membrane and a hollow fiber membrane were prepared as the cross-linked thermally rearranged polymer membrane.

The cross-linked thermally rearranged polymer membrane prepared in the present disclosure may be for separation of various gases, in particular, mixture gases of He/N₂, He/CH₄, He/CO₂, He/H₂, H₂/CO₂, H₂/N₂, H₂/CH₄, CO₂/CH₄, O₂/N₂, or N₂/CH₄.

As the cross-linked thermally rearranged polymer membrane, having a repeat unit represented by <Chemical Formula 1> or <Chemical Formula 2>, a poly(benzoxazole-imide) copolymer is based on the synthesis of o-hydroxydiamine prepared from imidization of polyamic acid obtained by reacting an acid dianhydride with o-hydroxydiamine. In addition, as seen from the structural unit of the y-side of <Chemical Formula 1> or the x-side of <Chemical Formula 2>, in order to form a cross-linked structure through thermal cross-linking, there should be a polyimide copolymer structure derived from a diamine compound having a functional group such as carboxylic acid. During the thermal rearrangement, a carboxy-benzoxazole intermediate is formed as the o-hydroxy group of the aromatic imide ring attacks the carbonyl group of the imide ring. Then, the intermediate is transited into a polybenzoxazole by decarboxylation.

That is to say, the present disclosure provides a method for preparing a cross-linked thermally rearranged polymer membrane produced by direct fluorination, having a repeat unit represented by <Chemical Formula 1> or <Chemical Formula 2>, which includes: I) a step of synthesizing an o-hydroxypolyimide copolymer having carboxylic acid; II) a step of preparing a membrane by casting a polymer solution in which the copolymer is dissolved in an organic solvent or by spinning a dope solution containing the copolymer, an organic solvent and an additive; III) a step of obtaining a membrane having a cross-linked structure by thermally cross-linking the membrane; IV) a step of thermally rearranging the membrane having a cross-linked structure; and V) a step of directly fluorinating the cross-linked thermally rearranged polymer membranes.

In general, to synthesize polyimide, polyamic acid should be prepared first by reacting an acid dianhydride with a diamine. In the present disclosure, a compound represented by <General Formula 1> or <General Formula 2> is used as an acid dianhydride.

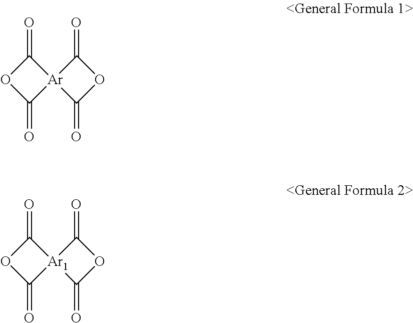

wherein Ar is the same as defined in <Chemical Formula 1> and Ar₁ is the same as defined in <Chemical Formula 2>.

The acid dianhydride as the monomer for synthesis of polyimide is not limited as long as it is one defined by <General Formula 1> or <General Formula 2>. Specifically, 4,4′-(hexafluoroisopropylidene)diphthalic anhydride (6FDA) or 4,4′-oxydiphthalic anhydride (ODPA) may be used.

In addition, in the present disclosure, a compound represented by <General Formula 3> is used as o-hydroxydiamine so as to introduce the polybenzoxazole unit by thermally rearranging the o-hydroxydiamine.

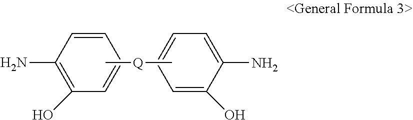

In <General Formula 3>, Q is the same as defined in <Chemical Formula 1> or <Chemical Formula 2>.

As the o-hydroxydiamine, any one defined by <General Formula 3> may be used without limitation. More specifically, 3,3-dihydroxybenzidine (HAB) or 2,2-bis(3-amino-4-hydroxyphenyl)hexafluoropropane (APAF) may be used.

In the present disclosure, the o-hydroxypolyimide copolymer having carboxylic acid may be synthesized by reacting the acid dianhydride of <General Formula 1> or <General Formula 2> with the o-hydroxydiamine of <General Formula 3> using an aromatic diamine not containing a carboxylic acid group, represented by <General Formula 4>, and 3,5-diaminobenzoic acid as a comonomer.

<General Formula 4>

H₂N—Ar₂NH₂

In <General Formula 4>, Ar₂ is the same as defined in <Chemical Formula 2>.

As the aromatic diamine not containing a carboxylic acid group, one defined by <General Formula 4> may be used without limitation. Specifically, one which is inexpensive may be used because the cost of mass production can be reduced. More specifically, 2,4,6-trimethyl-phenylenediamine (DAM) may be used.

That is to say, after obtaining a polyamic acid solution by dissolving the acid dianhydride of <General Formula 1>, the o-hydroxydiamine of <General Formula 3> and 3,5-diaminobenzoic acid or the acid dianhydride of <General Formula 2>, the o-hydroxydiamine of <General Formula 3>, the aromatic diamine not containing a carboxylic acid group of <General Formula 4>and 3,5-diaminobenzoic acid in an organic solvent such as N-methylpyrrolidone (NMP), the o-hydroxypolyimide copolymer having carboxylic acid represented by <Chemical Formula 3>or <Chemical Formula 4> is synthesized by azeotropic thermal imidization.

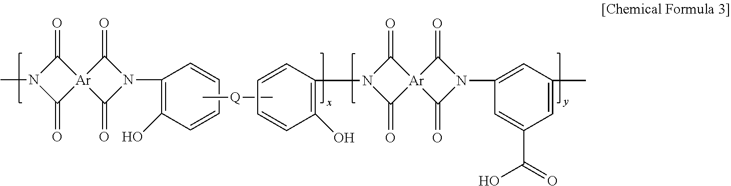

In <Chemical Formula 3>, Ar, Q, x and y are the same as defined in <Chemical Formula 1>.

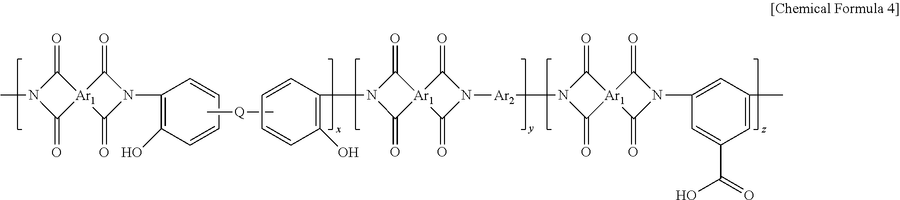

In <Chemical Formula 4>, Ar₁, Q, Ar₂, x, y and z are the same as defined in <Chemical Formula 2>.

The azeotropic thermal imidization is conducted by adding toluene or xylene to the polyamic acid solution and performing imidization at 180-200° C. for 6-24 hours under stirring. Through this process, water released as an imide ring is produced is separated as an azeotropic mixture with toluene or xylene.

Then, a membrane in the form of a flat-sheet membrane or a hollow fiber membrane may be prepared by casting a polymer solution in which the synthesized o-hydroxypolyimide copolymer having carboxylic acid is dissolved in an organic solvent or by spinning a dope solution containing the copolymer, an organic solvent and an additive.

As the organic solvent, one selected from a group consisting of N-methylpyrrolidone (NMP), dimethylacetamide (DMAc), dimethylformamide (DMF), dimethyl sulfoxide (DMSO), γ-butyrolactam (GBL), propionic acid (PA) and a mixture thereof may be used. More specifically, N-methylpyrrolidone (NMP) may be used.

In particular, a hollow fiber membrane may be formed by spinning a dope solution using a mixture of N-methylpyrrolidone (NMP) and propionic acid (PA) as an organic solvent (NMP:PA=99:1-50:50 mol %), because the free volume of a selection layer may be increased during formation of the hollow fiber membrane due to swelling of the mixture of N-methylpyrrolidone (NMP) and propionic acid (PA) through formation of a Lewis acid-base complex.

In addition, as the additive constituting the dope solution, one selected from a group consisting of acetic acid, tetrahydrofuran, acetone, 1,4-dioxane, trichloroethane, ethylene glycol, methanol, ethanol, isopropanol, 2-methyl-1-butanol, 2-methyl-2-butanol, 2-pentanol, glycerol, polyethylene glycol, polyethylene oxide and a mixture thereof may be used. In particular, ethylene glycol may be used because it has an excellent property of preventing formation of defects on the surface of the hollow fiber membrane.

Specifically, the polymer solution may have a concentration of 10-30 wt %. If the concentration of the polymer solution is below 10 wt %, the mechanical strength of the membrane prepared therefrom may be unsatisfactory. And, if the concentration of the polymer solution exceeds 30 wt %, it is difficult to obtain a uniform membrane without defects because of too high viscosity.

Specifically, the dope solution may contain 10-30 wt % of the polyimide copolymer represented by <Chemical Formula 3> or <Chemical Formula 4>, 20-80 wt % of the organic solvent and 5-30 wt % of the additive. If the content of the polyimide copolymer is lower than 10 wt %, selectivity may decrease because the pore size of the hollow fiber membrane is increased due to low viscosity of the dope solution. And, if the content exceeds 30 wt %, it is difficult to obtain a uniform dope solution. Therefore, the content of the polyimide copolymer in the dope solution may be specifically 10-30 wt %. Accordingly, when a dope solution having a viscosity of 1,000-100,000 cps is used, it is easy to prepare a hollow fiber membrane and the prepared hollow fiber membrane has superior mechanical properties.

Next, a membrane having a cross-linked structure represented by <Chemical Formula 5> or <Chemical Formula 6> is obtained by thermally cross-linking the membrane obtained in the step II).

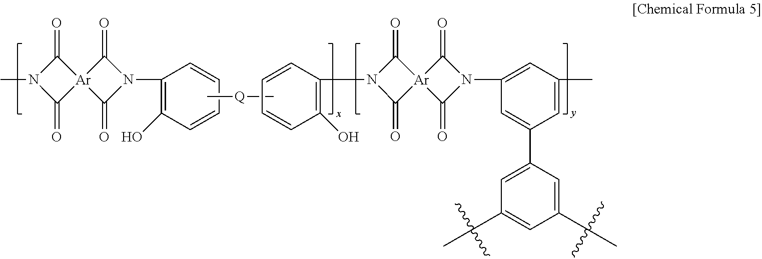

In <Chemical Formula 5>, Ar, Q, x and y are the same as defined in

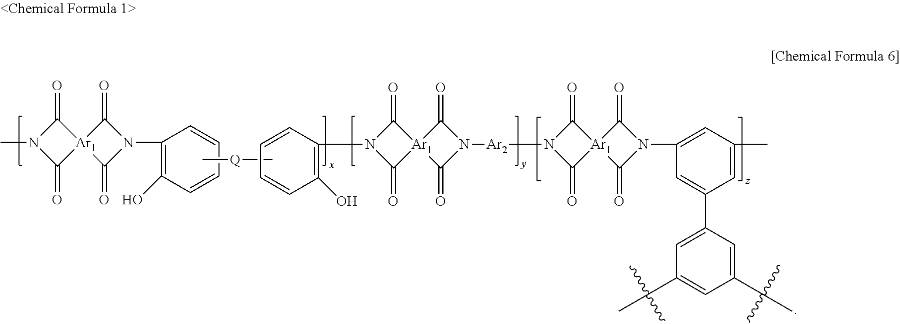

In <Chemical Formula 6>, Ar₁, Q, Ar₂, x, y and z are the same as defined in <Chemical Formula 2>.

The thermal cross-linking is conducted by heating the membrane obtained in the step II) to 250-350° C. at a heating rate of 1-20° C./min under an inert gas atmosphere and then maintaining the temperature for 0.1-6 hour(s).

Then, a cross-linked thermally rearranged polymer membrane having the repeat unit represented by <Chemical Formula 1> or <Chemical Formula 2> is obtained by heating the membrane having a cross-linked structure obtained in the step III) to 350-450° C. at a heating rate of 1-20° C./min under an inert gas atmosphere and then maintaining the temperature for 0.1-6 hour(s).

Finally, a fluorinated thermally rearranged polymer gas separation membrane desired by the present disclosure is prepared by directly fluorinating the cross-linked thermally rearranged polymer membrane.

During the direct fluorination, the polymer membrane may be damaged if a high-concentration fluorine gas is injected directly to the cross-linked thermally rearranged polymer membrane. Therefore, a mixture gas of fluorine gas and a dilution gas is used. Specifically, an inert gas such as nitrogen, argon or helium is used as the dilution gas to prevent side reactions during the direct fluorination.

Specifically, the direct fluorination may be conducted for 1 minute to 24 hours using a mixture gas containing 1 ppm to 1 vol % of fluorine gas. The temperature and pressure during the direct fluorination are not particularly limited. When considering the high reactivity and economical efficiency of fluorine, the direct fluorination may be conducted at room temperature and normal pressure.

Due to the direct interaction between the polymer chain of the cross-linked thermally rearranged polymer membrane, obtained from the direct fluorination according to the present disclosure, and fluorine atoms, the fluorine atoms are distributed to have a concentration gradient from the surface of the membrane. As a result, the cross-linked thermally rearranged polymer membrane is formed into a fluorine deposition layer, a transition layer and a thermally rearranged polymer base layer and the pores are controlled, such that selectivity is remarkably improved as compared to the existing commercialized gas separation membrane.

Hereinafter, examples for preparing a cross-linked thermally rearranged polymer membrane according to the present disclosure are described in detail referring to the attached drawings.

### EXAMPLE 1

### Preparation of a Cross-Linked Thermally Rearranged Polymer Membrane (Flat-Sheet Membrane)

<Synthesis of o-Hydroxypolyimide Copolymer having Carboxylic Acid>

5.0 mmol of 3,3-dihydroxybenzidine (HAB), 4.5 mmol of 2,4,6-trimethylphenylenediamine (DAM) and 0.5 mmol of 3,5-diaminobenzoic acid (DABA) were dissolved in 10 mL of anhydrous NMP. After cooling to 0° C., 10 mmol of 4,4′-(hexafluoroisopropylidene)diphthalic anhydride (6FDA) dissolved in 10 mL of anhydrous NMP was added. The reaction mixture was stirred at 0° C. for 15 minutes and then kept overnight after heating to room temperature to obtain a viscous polyamic acid solution. After adding 20 mL of o-xylene to the polyamic acid solution, imidization was conducted for 6 hours by heating at 180° C. under vigorous stirring. During this process, water released as an imide ring was produced was separated as an azeotropic mixture with xylene. The obtained brown solution was cooled to room temperature, added dropwise to distilled water, washed several timed with warm water and then dried in a convection oven at 120° C. for 12 hours. Through this process, o-hydroxypolyimide copolymer having carboxylic acid represented by Chemical Formula 7 was synthesized.

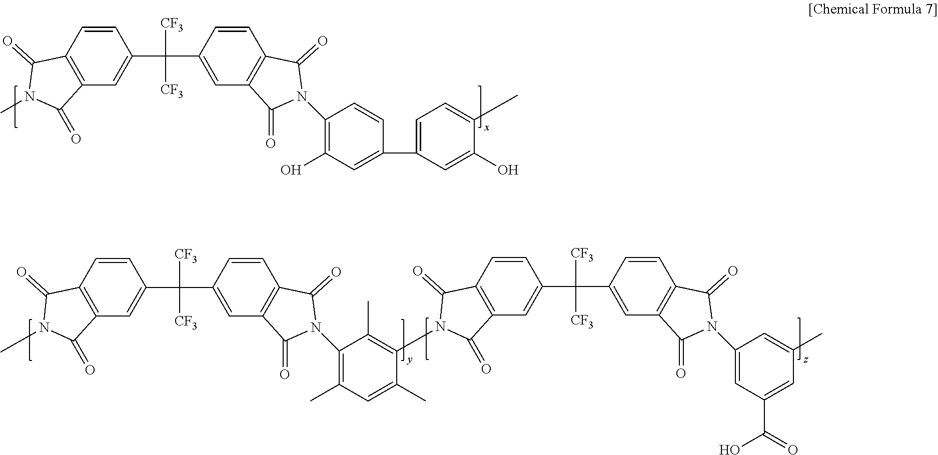

In <Chemical Formula 7>, x, y and z are molar ratios of the corresponding repeat units: x=0.5, y=0.45, z=0.05. The synthesis of the o-hydroxypolyimide copolymer having carboxylic acid represented by <Chemical Formula 7> was confirmed by FT-IR data: v (O—H) at 3460 cm⁻¹, (C—H) at 2920 and 2980 cm⁻¹, v (C═O) at 1784 and 1725 cm⁻¹, Ar (C—C) at 1619 and 1573 cm⁻¹, imide v (C—N) at 1359 cm⁻¹, (C-F) at 1295-1140 cm⁻¹, imide (C—N—C) at 1099 cm⁻¹.

<Preparation of Membrane from o-Hydroxypolyimide Copolymer having Carboxylic Acid>

A 15 wt % polymer solution prepared by dissolving the synthesized o-hydroxypolyimide copolymer having carboxylic acid in NMP was cast on a glass plate and a flat-sheet membrane was prepared by drying in a vacuum oven at 80° C.

<Thermal Cross-Linking>

A membrane having a cross-linked structure represented by <Chemical Formula 8> was obtained by heating the prepared flat-sheet membrane to 300° C. at a rate of 5° C./min under a high-purity argon gas atmosphere and maintaining the temperature at 300° C. for 1 hour.

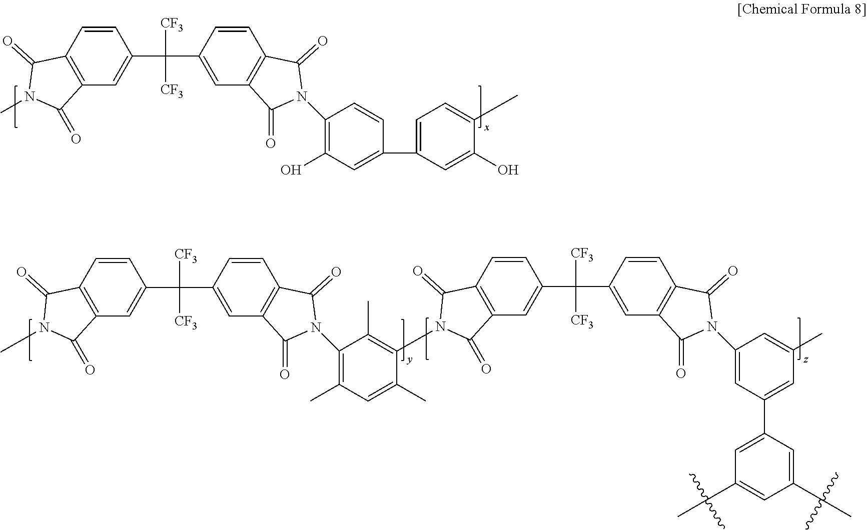

In <Chemical Formula 8>, x, y and z are the same as defined in <Chemical Formula 7>.

<Thermal Rearrangement>

A cross-linked thermally rearranged polymer membrane represented by <Chemical Formula 9> was obtained by heating the membrane having a cross-linked structure obtained by the thermal cross-linking to 425° C. at a rate of 1° C./min under a high-purity argon gas atmosphere and maintaining the temperature at 425° C. for 0.5 hour.

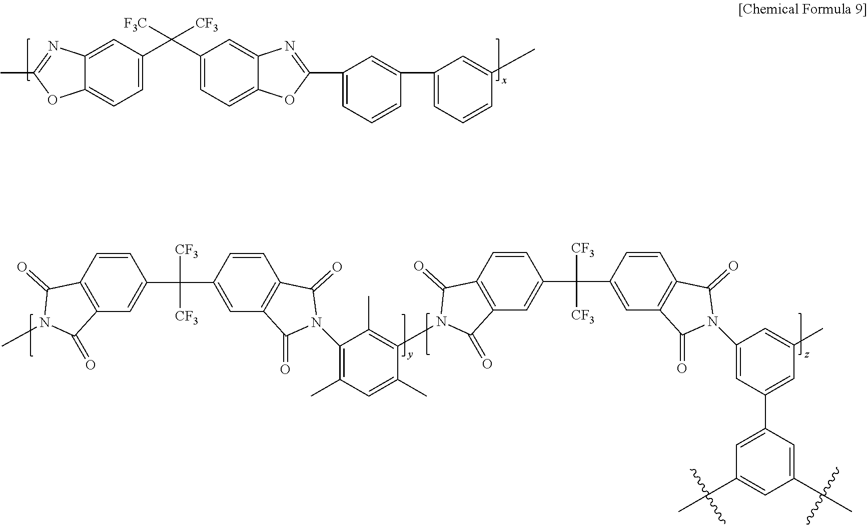

In <Chemical Formula 9>, x, y and z are the same as defined in <Chemical Formula 7>.

<Direct Fluorination>

A fluorinated cross-linked thermally rearranged polymer membrane was prepared by putting the cross-linked thermally rearranged polymer membrane represented by <Chemical Formula 9> in an oven at 25° C. and 1 atm and conducting direct fluorination by injecting a mixture gas wherein fluorine gas was diluted with a high-purity nitrogen gas having a concentration of 500 ppm for 30 minutes.

### EXAMPLES 2-7

### Preparation of Cross-Linked Thermally Rearranged Polymer Membranes (Flat-Sheet Membrane)

Cross-linked thermally rearranged polymer membranes were prepared in the same manner as in Example 1, except that the direct fluorination time was changed to 60 minutes, 90 minutes, 120 minutes, 150 minutes, 300 minutes and 500 minutes, respectively.

### EXAMPLE 8

### Preparation of a Cross-Linked Thermally Rearranged Polymer Membrane (Flat-Sheet Membrane)

A cross-linked thermally rearranged polymer membrane was prepared in the same manner as in Example 1, except that 4,4′-oxydiphthalic anhydride (ODPA) was used as an acid dianhydride for synthesizing the o-hydroxypolyimide copolymer having carboxylic acid and the direct fluorination was conducted for 300 minutes.

### COMPARATIVE EXAMPLE 1

### Preparation of an Unfluorinated Cross-Linked Thermally Rearranged Polymer Membrane (Flat-Sheet Membrane)

A cross-linked thermally rearranged polymer membranes was prepared in the same manner as in Example 1, except that the direct fluorination was not conducted.

### COMPARATIVE EXAMPLE 2

### Teflon (PTFE) Membrane

A commercially available Teflon (PTFE) flat-sheet membrane was used for comparison.

### EXAMPLE 9

### Preparation of a Cross-Linked Thermally Rearranged Polymer Membrane (Hollow Fiber Membrane)

<Synthesis of o-Hydroxypolyimide Copolymer having Carboxylic Acid>

o-Hydroxypolyimide copolymer having carboxylic acid represented by <Chemical Formula 7> was synthesized in the same manner as in Example 1.

<Preparation of Membrane from o-Hydroxypolyimide Copolymer having Carboxylic Acid>

A uniform dope solution was obtained by adding 25 wt % of the synthesized o-hydroxypolyimide copolymer having carboxylic acid to 65 wt % of a mixture of N-methylpyrrolidone (NMP) and propionic acid (PA) (NMP:PA=50:50 mol %), mixing with 10 wt % of ethylene glycol as an additive and then stirring the mixture at 35° C. for 12 hours. After removing foams from the dope solution for 12 hours at room temperature under reduced pressure, impurities were removed using a metal filter (pore diameter: 60 μm). Then, the dope solution was supplied to and discharged from a double spinning nozzle together with a bore solution. The temperature of a dope solution pipeline and a nozzle passing through a gear pump was maintained at 60° C. The discharge rate of the dope solution was set to 1.0 mL/min, the air gap to 5 cm. Water was used as the bore solution (internal coagulant). The dope solution discharged from the spinning nozzle was spun into a coagulation bath (first bath) filled with water of 80° C. to induce phase transition. A hollow fiber obtained after the phase transition was completed was wound at a rate of 15 m/min after sufficiently removing the residual solvent in washing baths (second to fourth baths) filled with water of 40° C. After completely removing the residual solvent from the wound hollow fiber in a washing bath filled with water of 35° C. for 3 days and further washing for 1 hour with ethanol, a hollow fiber membrane was prepared by drying at room temperature for 24 hours.

<Thermal Cross-Linking>

A hollow fiber membrane having a cross-linked structure was obtained by thermally cross-linking the prepared hollow fiber membrane in the same manner as in Example 1.

<Thermal Rearrangement>

A cross-linked thermally rearranged polymer hollow fiber membrane was obtained by conducting thermal rearrangement of the hollow fiber membrane having a cross-linked structure in the same manner as in Example 1.

<Direct Fluorination>

A fluorinated cross-linked thermally rearranged polymer hollow fiber membrane was prepared by conducting direct fluorination of the cross-linked thermally rearranged polymer hollow fiber membrane in the same manner as in Example 1, except that the direct fluorination was performed for 3 minutes.

### EXAMPLES 10-14

### Preparation of Cross-Linked Thermally Rearranged Polymer Membranes (Hollow Fiber Membrane)

Cross-linked thermally rearranged polymer hollow fiber membranes were prepared in the same manner as in Example 9, except that the direct fluorination time was changed to 5 minutes, 7 minutes, 15 minutes, 30 minutes and 45 minutes, respectively.

### EXAMPLE 15

### Preparation of Cross-Linked Thermally Rearranged Polymer Membrane (Hollow Fiber Membrane)

A cross-linked thermally rearranged polymer hollow fiber membrane was prepared in the same manner as in Example 9, except that 4,4′-oxydiphthalic anhydride (ODPA) was used as an acid dianhydride for synthesizing the o-hydroxypolyimide copolymer having carboxylic acid and the direct fluorination was conducted for 300 minutes.

### EXAMPLE 16

### Preparation of a Cross-Linked Thermally Rearranged Polymer Membrane (Hollow Fiber Membrane)

A cross-linked thermally rearranged polymer fiber membrane was prepared in the same manner as in Example 9, except that the direct fluorination time was changed to 1 minute.

### COMPARATIVE EXAMPLE 3

### Preparation of Unfluorinated Cross-Linked Thermally Rearranged Polymer Membrane (Hollow Fiber Membrane)

A cross-linked thermally rearranged polymer hollow fiber membrane was prepared in the same manner as in Example 9, except that the direct fluorination was not conducted.

### COMPARATIVE EXAMPLE 4

### Preparation of Unfluorinated Cross-Linked Thermally Rearranged Polymer Membrane (Hollow Fiber Membrane)

A cross-linked thermally rearranged polymer hollow fiber membrane was prepared in the same manner as in Example 15, except that the direct fluorination was not conducted.

The mechanical properties of the cross-linked thermally rearranged polymer membranes according to the examples of the present disclosure and the unfluorinated cross-linked thermally rearranged polymer membranes of the comparative examples are shown in Table 1. As can be seen from Table 1, the cross-linked thermally rearranged polymer membrane prepared in Example 7 shows no significant difference in physical properties such as tensile strength, extensibility, elasticity, etc. from the unfluorinated cross-linked thermally rearranged polymer membrane prepared in Comparative Example 1, although the direct fluorination time was 500 minutes. Accordingly, it was confirmed that the cross-linked thermally rearranged polymer membrane maintains mechanical properties well without defects even after the direct fluorination process.

TABLE 1

| | Membrane | Tensile | | |
|---|---|---|---|---|
| | thickness | strength | Extensibility | Elasticity |
| Sample | (μm) | (MPa) | (%) | (MPa) |
| Example 1 | 59 ± 4.2 | 99 ± 4.1 | 21 ± 1.8 | 644 ± 32.9 |
| Example 2 | 58 ± 1.2 | 100 ± 1.8 | 23 ± 1.0 | 664 ± 30.3 |
| Example 3 | 61 ± 6.8 | 107 ± 6.4 | 23 ± 3.5 | 684 ± 9.3 |
| Example 6 | 65 ± 2.9 | 95 ± 4.5 | 20 ± 1.7 | 644 ± 12.3 |
| Example 7 | 57 ± 3.7 | 100 ± 4.9 | 21 ± 2.2 | 662 ± 42.7 |
| Comparative | 55 ± 2.4 | 101 ± 5.9 | 23 ± 1.3 | 661 ± 31.4 |
| Example 1 | | | | |

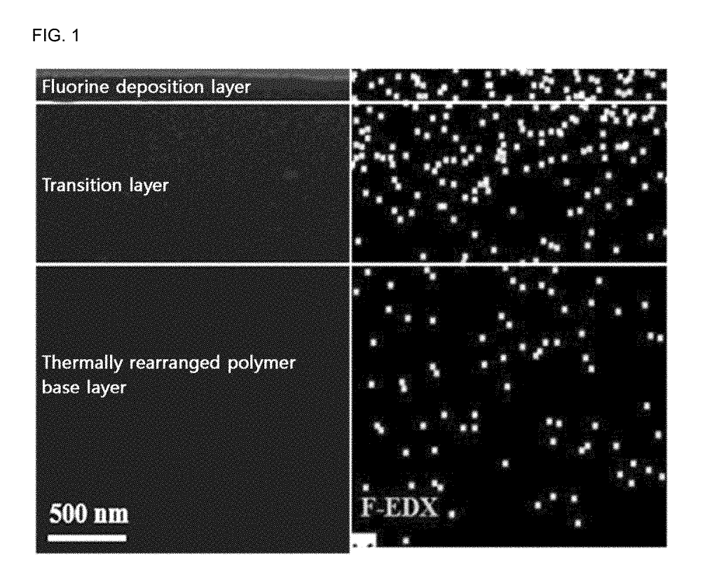

Also, in order to visually confirm the effect of direct fluorination according to the present disclosure, the pristine cross-linked thermally rearranged polymer membrane not containing fluorine atoms in the polymer repeat unit was subjected to measurement. FIG. 1 shows a cross-sectional image of the cross-linked thermally rearranged polymer membrane prepared in Example 8 according to the present disclosure obtained by focused ion beam-scanning electron microscopy-energy-dispersive X-ray analysis (FIB-SEM-EDX).

From FIG. 1, it can be seen that the white dots, which are substituted fluorine radicals penetrating through pores, have penetrated up to 1 μm from the membrane surface and are distributed to have a concentration gradient, thereby forming a three-layer structure consisting of a fluorine deposition layer, a transition layer and a thermally rearranged polymer base layer.

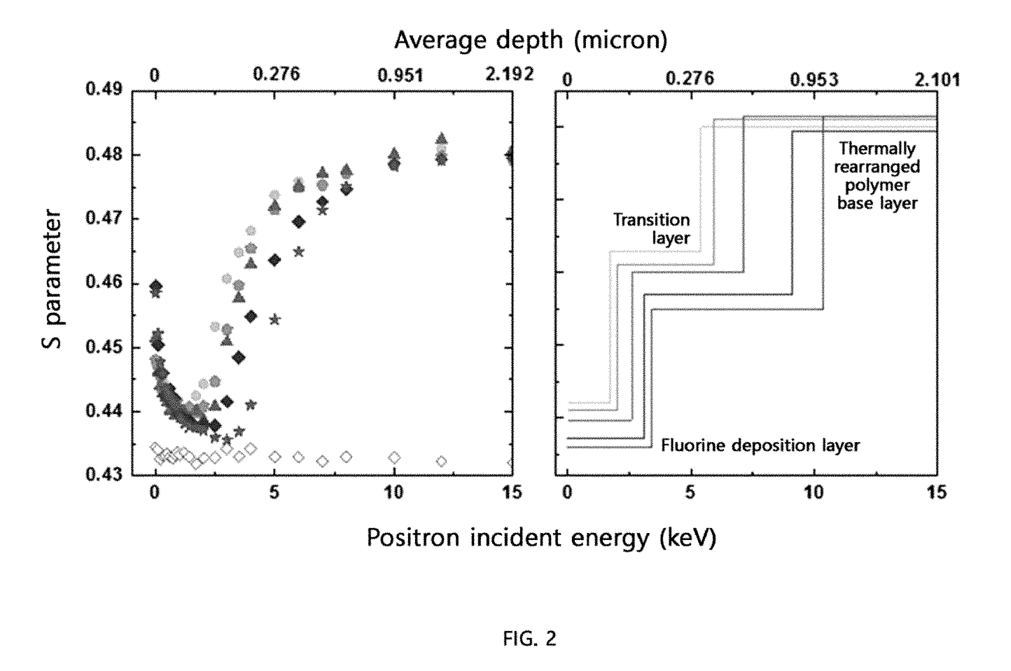

FIG. 2 shows the change in the S parameter [a value proportional to the fractional free volume (FFV)] up to 2 μm from the surface of the cross-linked thermally rearranged polymer membranes prepared in Examples 1-3, 5 and 6 according to the present disclosure and Comparative Example 2 (PTFE membrane), determined by Doppler broadening energy spectroscopy (DBES) [Example 1 (●), Example 2 (▪), Example 3 (▴), Example 5 (♦), Example 6 (★), Comparative Example 2 (⋄)].

The change in the S parameter shown in FIG. 2 further corroborates the three-layer structure of the cross-linked thermally rearranged polymer membrane consisting of the fluorine deposition layer, the transition layer and the thermally rearranged polymer base layer shown in FIG. 1. It can be seen that the decrease of the S parameter in each layer increases with the direct fluorination time whereas the thermally rearranged polymer base layer is almost similar. Therefore, as the direct fluorination time is increased, the depth of the two different layers from the surface is increased, which suggests that fluorine penetrates deep into the membrane as the direct fluorination time is increased.

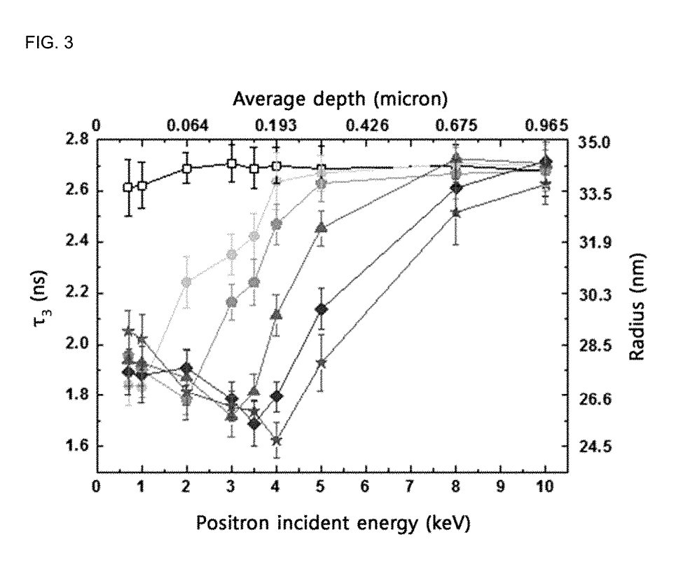

FIG. 3 shows the change in T₃ (a value proportional to the pore size at the waist portion of the hourglass-shaped pore distribution of the thermally rearranged polymer) and pore radius up to 1 μm from the surface of the cross-linked thermally rearranged polymer membrane prepared in Examples 1-3, 5 and 6 according to the present disclosure and Comparative Example 1, determined by slow beam positron annihilation lifetime spectroscopy (SB-PALS) [Example 1 (●), Example 2 (▪), Example 3 (▴), Example 5 (♦), Example 6 (★), Comparative Example 1 (⋄)].

From FIG. 3, it can be seen that the pore distribution in each of the fluorine deposition layer, the transition layer and the thermally rearranged polymer base layer shown in FIGS. 1 and 2 is continuously different. Up to the minimum point which represents being in the fluorine deposition layer, the pore size gets larger toward the surface because fluorine is distributed sparsely. Because the fluorine penetrating through the membrane pores is substituted to have a concentration gradient, the transition layer exhibits a similar behavior to the thermally rearranged polymer base layer as getting close thereto. Such an exhibition becomes more distinct as the direct fluorination time is increased.

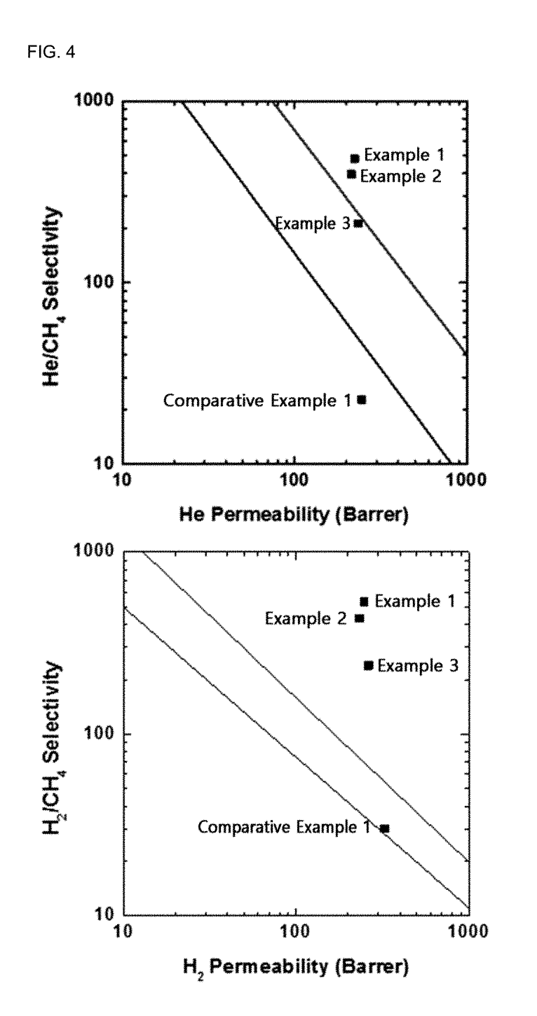

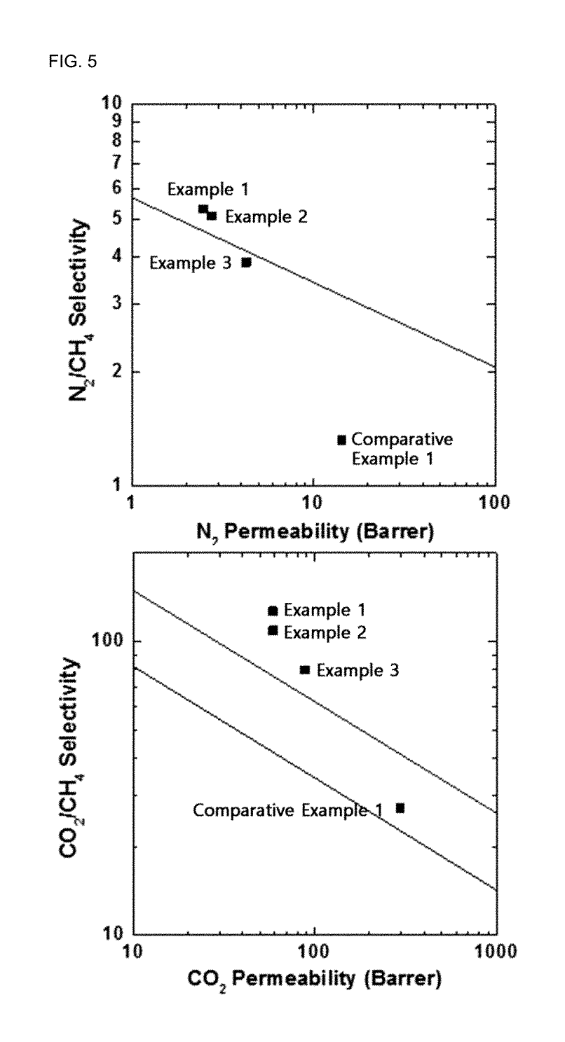

FIG. 4 shows the natural gas separation performance (He/CH₄, H₂/CH₄) of the cross-linked thermally rearranged polymer membranes prepared in Examples 1-3 according to the present disclosure and the unfluorinated cross-linked thermally rearranged polymer membrane prepared in Comparative Example 1 and FIG. 5 shows the natural gas separation performance (N₂/CH₄, CO₂/CH₄), together with the 2008 Robeson upper bounds. From FIG. 4 and FIG. 5, the effect of the pore distribution of the cross-linked thermally rearranged polymer membrane confirmed in FIGS. 1-3 on the improvement of natural gas separation performance depending on fluorination time can be confirmed in detail. First, the cross-linked thermally rearranged polymer membrane showed significant improvement in the separation performance as compared to the unfluorinated membrane, better or comparable to the 2008 Robeson upper bounds regardless of the fluorination time. In particular, the membrane of Example 1 (fluorination time: 30 minutes) showed the best natural gas separation performance.

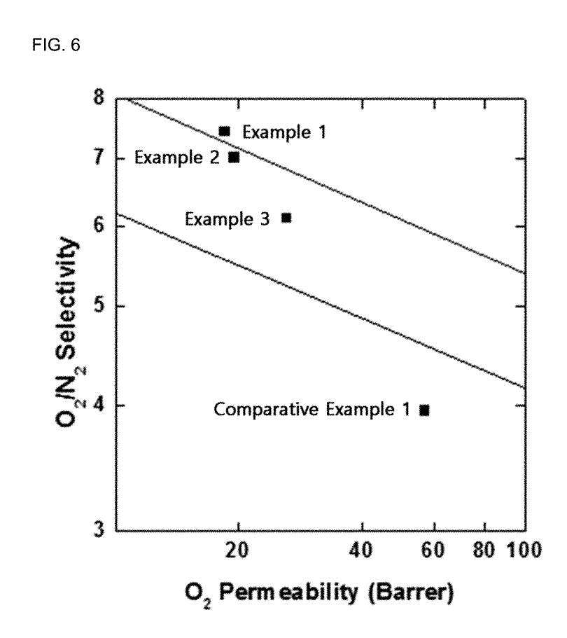

FIG. 6 shows the air separation performance (O₂/N₂) of the cross-linked thermally rearranged polymer membranes prepared in Examples 1-3 according to the present disclosure and the unfluorinated cross-linked thermally rearranged polymer membrane prepared in Comparative Example 1 together with the 2008 Robeson upper bounds. FIG. 6 also confirms the improvement in separation performance and the effect of fluorination time as confirmed in FIG. 4 and FIG. 5.

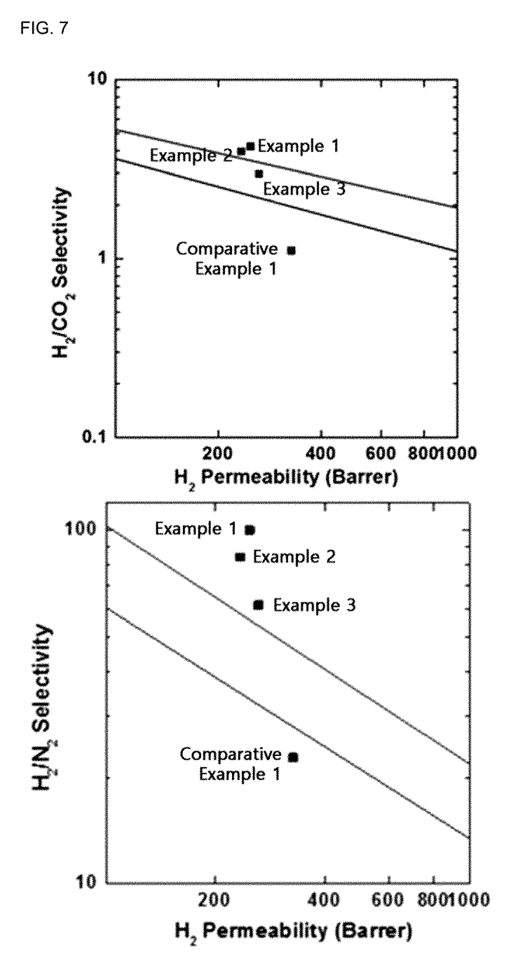

FIG. 7 shows the hydrogen separation performance (H₂/CO₂, H₂/N₂) of the cross-linked thermally rearranged polymer membranes prepared in Examples 1-3 according to the present disclosure and the unfluorinated cross-linked thermally rearranged polymer membrane prepared in Comparative Example 1 together with the 2008 Robeson upper bounds. FIG. 7 also confirms the improvement in separation performance and the effect of fluorination time as confirmed in FIGS. 4-6.

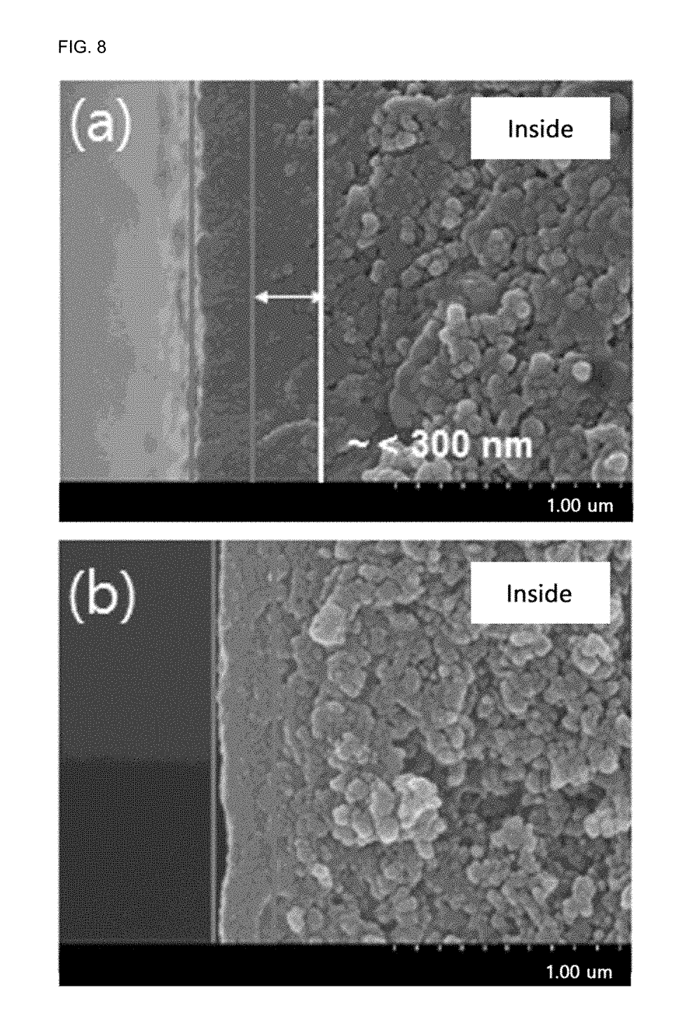

FIG. 8 shows scanning electron microscopy (SEM) images showing the morphology inside the cross-linked thermally rearranged polymer hollow fiber membrane prepared in Example 13 according to the present disclosure (a) and the unfluorinated cross-linked thermally rearranged polymer hollow fiber membrane prepared in Comparative Example 3 (b).

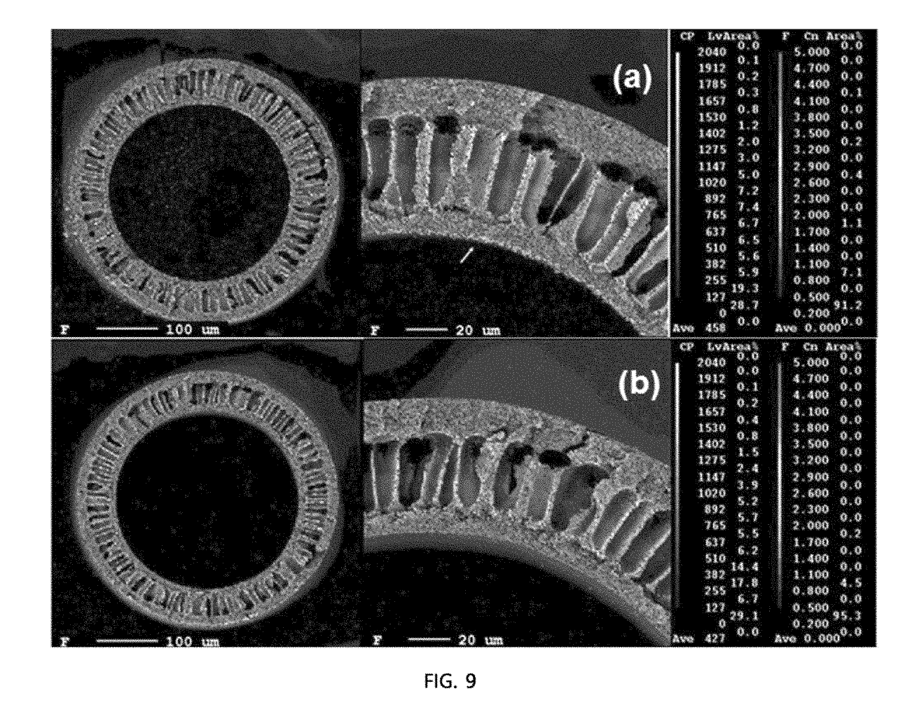

FIG. 9 shows images of the cross-linked thermally rearranged polymer hollow fiber membrane prepared in Example 15 according to the present disclosure (a) and the unfluorinated cross-linked thermally rearranged polymer hollow fiber membrane prepared in Comparative Example 4 (b) obtained with an electron probe X-ray microanalyzer (EPMA). The region substituted with fluorine is clearly seen as indicated by the arrow in FIG. 9(a).

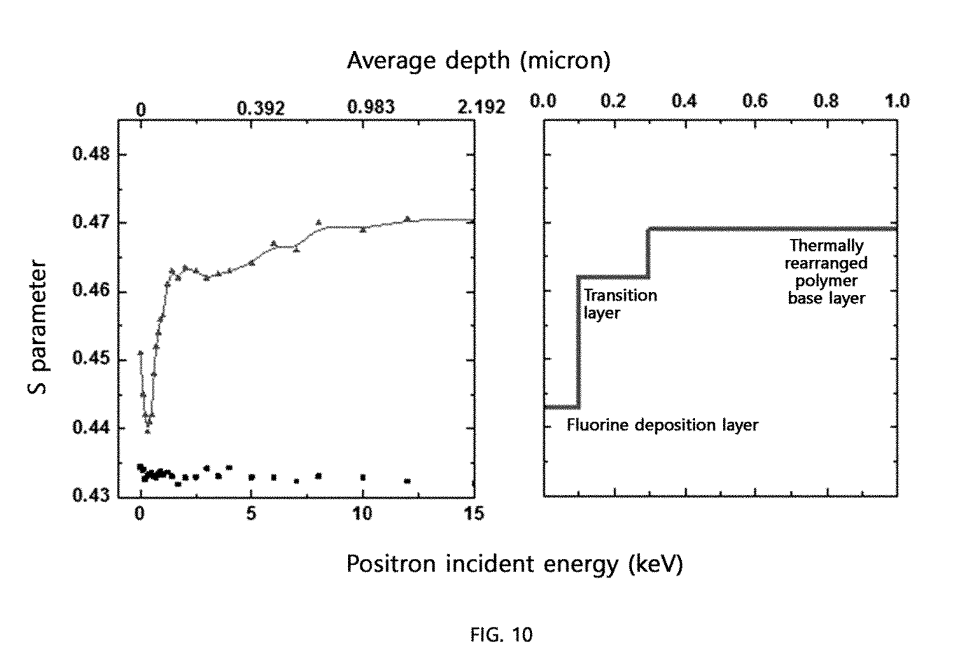

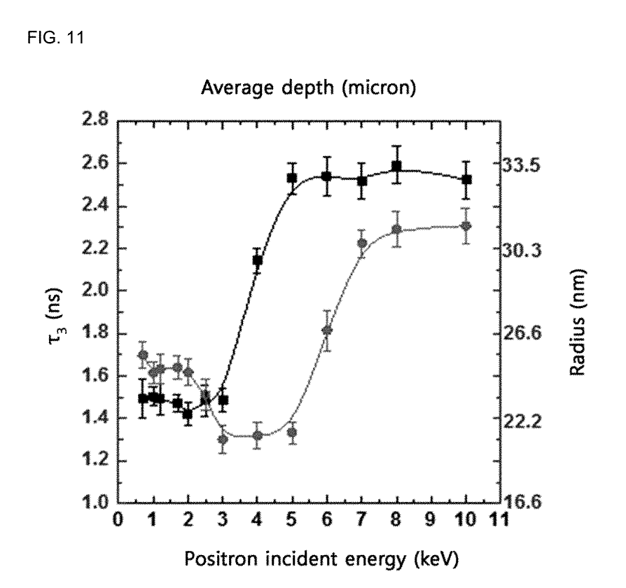

FIG. 10 shows the change in the S parameter [a value proportional to the fractional free volume (FFV)] up to 1 μm from the surface of the cross-linked thermally rearranged polymer membrane prepared in Example 13 according to the present disclosure and Comparative Example 2, determined by Doppler broadening energy spectroscopy (DBES), and FIG. 11 shows the change in T₃ (a value proportional to the pore size at the waist portion of the hourglass-shaped pore distribution of the thermally rearranged polymer) and pore radius up to 1 μm from the surface of the cross-linked thermally rearranged polymer membrane prepared in Example 13 according to the present disclosure and Comparative Example 2, determined by slow beam positron annihilation lifetime spectroscopy (SB-PALS). As in the flat-sheet membrane, it was confirmed also in the hollow fiber membrane that fluorine atoms were distributed to have a concentration gradient from the membrane surface to form a three-layer structure consisting of a fluorine deposition layer, a transition layer and a thermally rearranged polymer base layer.

Permeance and selectivity for various gases were measured in order to investigate the gas separation performance of the cross-linked thermally rearranged polymer follow fiber membrane prepared according to the present disclosure. The result is shown in Tables 2 and 3.

TABLE 2

| | Gas permeance (GPU)^{a} | | | | | |
|---|---|---|---|---|---|---|
| | He | H₂ | O₂ | N₂ | CH₄ | CO₂ |
| Example 9 | 402 | 299 | 31 | 6.0 | 3.3 | 155 |
| Example 10 | 403 | 260 | 20 | 3.7 | 1.3 | 95 |
| Example 11 | 338 | 252 | 27 | 6.4 | 4.3 | 125 |
| Example 12 | 410 | 280 | 27 | 6.1 | 3.5 | 136 |
| Example 13 | 463 | 270 | 27 | 7.0 | 4.0 | 106 |
| Example 14 | 394 | 228 | 21 | 5.0 | 3.0 | 81 |
| Comparative | 665 | 944 | 196 | 51 | 37 | 830 |
| Example 3 | | | | | | |

^{a}1 GPU = 10⁻⁶ cm³ (STP)/(s cm² cmHg)

TABLE 3

| | Selectivity^{b} | | | | | | | |
|---|---|---|---|---|---|---|---|---|
| | He/N₂ | He/CH₄ | He/CO₂ | He/H₂ | H₂/CO₂ | CO₂/CH₄ | O₂/N₂ | N₂/CH₄ |
| Ex. 9 | 67 | 122 | 2.59 | 1.34 | 1.93 | 47 | 5.19 | 1.83 |
| Ex. 10 | 112 | 300 | 4.25 | 1.55 | 2.73 | 71 | 5.49 | 2.68 |
| Ex. 11 | 53 | 78 | 2.70 | 1.34 | 2.01 | 29 | 4.23 | 1.49 |
| Ex. 12 | 67 | 115 | 3.02 | 1.46 | 2.07 | 38 | 4.53 | 1.71 |
| Ex. 13 | 65 | 105 | 4.39 | 1.71 | 2.56 | 24 | 3.83 | 1.61 |
| Ex. 14 | 82 | 140 | 4.88 | 1.73 | 2.83 | 29 | 4.33 | 1.71 |
| Comp. Ex. 3 | 13 | 18 | 0.80 | 0.70 | 1.14 | 23 | 3.80 | 1.40 |

^{b}Selectivity: ratio of permeance of two gases

As seen from Tables 2 and 3, the cross-linked thermally rearranged polymer hollow fiber membrane prepared according to the present disclosure exhibited remarkably improved selectivity as compared to the unfluorinated cross-linked thermally rearranged polymer hollow fiber membrane prepared in Comparative Example 3. In particular, Example 10 (direct fluorination time: 5 minutes) showed superior separation performance for various gases.

In addition, in order to investigate the gas separation performance when the direct fluorination time was minimized, the gas separation performance of the cross-linked thermally rearranged polymer hollow fiber membrane prepared in Example 16 (direct fluorination time: 1 minute) and the cross-linked thermally rearranged polymer hollow fiber membrane prepared in Example 9 (direct fluorination time: 3 minutes) was compared as shown in Tables 4 and 5.

TABLE 4

Gas permeance (GPU)^{a}

| | He | H₂ | O₂ | N₂ | CH₄ | CO₂ |
|---|---|---|---|---|---|---|
| Example 9 | 402 | 299 | 31 | 6.0 | 3.3 | 155 |
| Example 16 | 678 | 487 | 25 | 3.27 | 0.85 | 110 |

^{a}1 GPU = 10⁻⁶ cm³ (STP)/(s cm² cmHg)

TABLE 5

| | Selectivity^{b} | | | | | | | |
|---|---|---|---|---|---|---|---|---|
| | He/N₂ | He/CH₄ | He/CO₂ | He/H₂ | H₂/CO₂ | CO₂/CH₄ | O₂/N₂ | N₂/CH₄ |
| Example 9 | 67 | 122 | 2.59 | 1.34 | 1.93 | 47 | 5.19 | 1.83 |
| Example 16 | 207 | 800 | 6.15 | 1.39 | 4.4 | 130 | 7.7 | 3.9 |

^{b}Selectivity: ratio of permeance of two gases

As seen from Table 5, selectivity for helium over methane, etc. was very superior even when the direct fluorination time was minimized to 1 minute, which suggests that selectivity can be increased remarkably even with a direct fluorination process for about 1 minute.

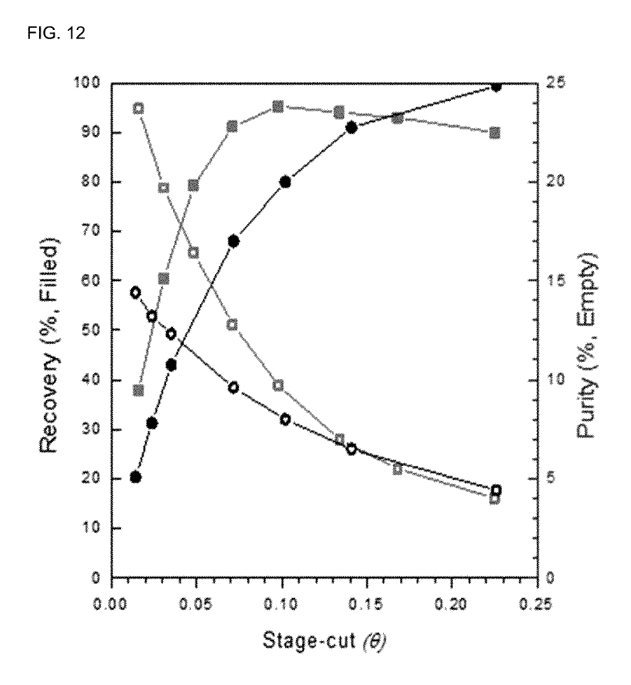

FIG. 12 shows the recovery rate and purity of a permeate from a mixture gas (1% helium/99% methane) feed depending on stage-cut when the hollow fiber membranes prepared in Example 16 according to the present disclosure and Comparative Example 3 were used [Example 16: red, Comparative Example 3: black]. It can be seen that helium of higher purity can be recovered with a larger amount for the same stage-cut when the direct fluorination process was conducted, which suggests that a given amount of helium can be recovered with higher purity even with a small membrane area.

The cross-linked thermally rearranged membrane prepared according to the present disclosure has fluorine atoms distributed in a thermally rearranged polymer membrane having a cross-linked structure so as to have a concentration gradient from the surface and is formed into a three-layer structure consisting of a fluorine deposition layer, a transition layer and a thermally rearranged polymer base layer, thereby having remarkably increased selectivity as compared to the existing commercialized gas separation membrane and, particularly, enabling helium to be separated with high purity and recovery rate from a natural gas well, etc. even with a small membrane area, and thus being commercializable.

1. A polymer gas separation membrane, having a repeat unit represented by <Chemical Formula 1> or <Chemical Formula 2>, wherein the membrane is formed into a fluorine deposition layer, a transition layer and a thermally rearranged polymer base layer as fluorine atoms are distributed to have a concentration gradient from the surface: 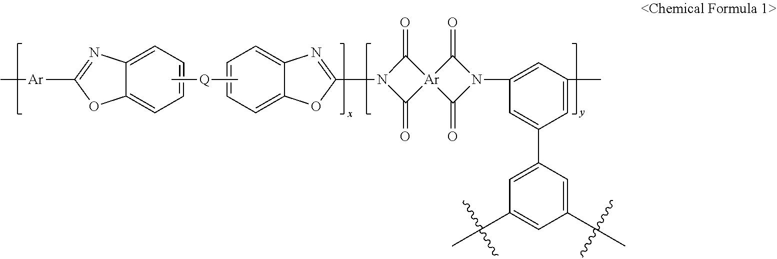
wherein
Ar is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,
Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group, and
x and y are the molar ratios of the corresponding repeat units, wherein both x and y are greater than 0 and x+y=1 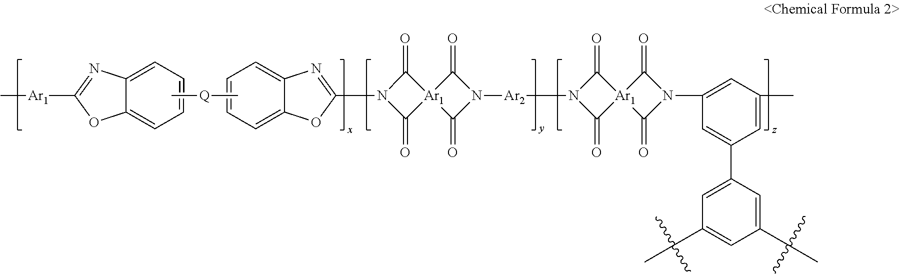
wherein
Ar₁ is an aromatic ring group selected from a substituted or unsubstituted tetravalent C₆-C₂₄ arylene group and a substituted or unsubstituted tetravalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH,
Q is a single bond, O, S, CO, SO₂, Si(CH₃)₂, (CH₂)ₚ (1≤p≤10), (CF₂)_{q} (1≤q≤10), C(CH₃)₂, C(CF₃)₂, CO—NH, C(CH₃)(CF₃) or a substituted or unsubstituted phenylene group,
Ar₂ is an aromatic ring group selected from a substituted or unsubstituted divalent C₆-C₂₄ arylene group and a substituted or unsubstituted divalent C₄-C₂₄ heterocyclic group, wherein the aromatic ring group exists independently, two or more of them form a condensed ring or two or more of them are linked by a single bond, O, S, CO, SO₂, Si(CH₃)₂, (CH₂)ₚ (1≤p≤10), (CF₂)_{q} (1≤q≤10), C(CH₃)₂, C(CF₃)₂ or CO—NH, and
x, y and z are the molar ratios of the corresponding repeat units, wherein all of x, y and z are greater than 0 and x+y+z=1.

2. The polymer gas separation membrane according to claim 1, wherein the gas separation membrane is a flat-sheet membrane, a hollow fiber membrane or a spiral wound membrane.

3. The polymer gas separation membrane according to claim 1, wherein the gas separation membrane is for separation of a mixture gas of He/N₂, He/CH₄, He/CO₂, He/H₂, H₂/CO₂, H₂/N₂, H₂/CH₄, CO₂/CH₄, O₂/N₂ or N₂/CH₄.

4. A method for preparing the polymer gas separation membrane, having a repeat unit represented by <Chemical Formula 1> or <Chemical Formula 2>, according to claim 1, comprising:
I) a step of synthesizing an o-hydroxypolyimide copolymer having carboxylic acid;
II) a step of preparing a membrane by casting a polymer solution in which the copolymer is dissolved in an organic solvent or by spinning a dope solution comprising the copolymer, an organic solvent and an additive;
III) a step of obtaining a membrane having a cross-linked structure by thermally cross-linking the membrane;
IV) a step of thermally rearranging the membrane having a cross-linked structure; and
V) a step of directly fluorinating the cross-linked thermally rearranged polymer membrane.

5. The method for preparing the polymer gas separation membrane according to claim 4, wherein the o-hydroxypolyimide copolymer having carboxylic acid is synthesized by azeotropic thermal imidization after obtaining a polyamic acid solution by reacting an acid dianhydride, o-hydroxydiamine and 3,5-diaminobenzoic acid as a comonomer.

6. The method for preparing the polymer gas separation membrane according to claim 5, wherein an aromatic diamine not comprising a carboxylic acid group is further used as a comonomer.

7. The method for preparing the polymer gas separation membrane according to claim 5, wherein the acid dianhydride is represented by <General Formula 1> or <General Formula 2>: 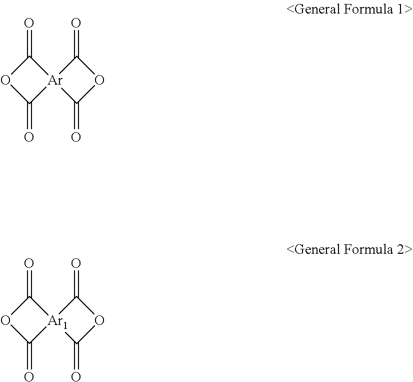
wherein Ar is the same as defined in <Chemical Formula 1> and Ar₁ is the same as defined in <Chemical Formula 2>.

8. The method for preparing the polymer gas separation membrane according to claim 5, wherein the o-hydroxydiamine is represented by <General Formula 3>: 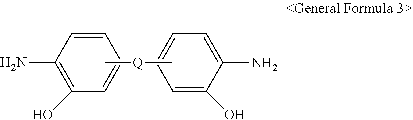
wherein Q is the same as defined in <Chemical Formula 1> or <Chemical Formula 2>.

9. The method for preparing the polymer gas separation membrane according to claim 6, wherein the aromatic diamine not comprising a carboxylic acid group is represented by <General Formula 4>:
H₂N—Ar₂—NH₂ <General Formula 4>
wherein Ar₂ is the same as defined in <Chemical Formula 2>.

10. The method for preparing the polymer gas separation membrane according to claim 5, wherein the azeotropic thermal imidization is conducted by adding toluene or xylene to the polyamic acid solution and performing imidization at 180-200° C. for 6-24 hours under stirring.

11. The method for preparing the polymer gas separation membrane according to claim 4, wherein the organic solvent is one selected from a group consisting of N-methylpyrrolidone (NMP), dimethylacetamide (DMAc), dimethylformamide (DMF), dimethyl sulfoxide (DMSO), γ-butyrolactam (GBL), propionic acid (PA) and a mixture thereof.

12. The method for preparing the polymer gas separation membrane according to claim 11, wherein the organic solvent is a mixture of N-methylpyrrolidone (NMP) and propionic acid (PA) (NMP:PA=99:1-50:50 mol %).

13. The method for preparing the polymer gas separation membrane according to claim 4, wherein the additive is one selected from a group consisting of acetic acid, tetrahydrofuran, acetone, 1,4-dioxane, trichloroethane, ethylene glycol, methanol, ethanol, isopropanol, 2-methyl-1-butanol, 2-methyl-2-butanol, 2-pentanol, glycerol, polyethylene glycol, polyethylene oxide and a mixture thereof.

14. The method for preparing the polymer gas separation membrane according to claim 4, wherein the polymer solution has a concentration of 10-30 wt %.

15. The method for preparing the polymer gas separation membrane according to claim 4, wherein the dope solution comprises 10-30 wt % of the copolymer, 20-80 wt % of the organic solvent and 5-30 wt % of the additive.

16. The method for preparing the polymer gas separation membrane according to claim 15, wherein the dope solution has a viscosity of 1,000-100,000 cp.

17. The method for preparing the polymer gas separation membrane according to claim 4, wherein the thermal cross-linking is conducted by heating the membrane obtained in the step II) to 250-350° C. at a heating rate of 1-20° C./min under an inert gas atmosphere and maintaining the temperature for 0.1-6 hour(s).

18. The method for preparing the polymer gas separation membrane according to claim 4, wherein the thermal rearrangement is conducted by heating the membrane having a cross-linked structure obtained in the step III) to 350-450° C. at a heating rate of 1-20° C./min under an inert gas atmosphere and maintaining the temperature for 0.1-6 hour(s).

19. The method for preparing the polymer gas separation membrane according to claim 4, wherein the direct fluorination in the step V) is conducted using a mixture gas comprising 1 ppm to 1 vol % of fluorine gas.

20. The method for preparing the polymer gas separation membrane according to claim 19, wherein the mixture gas comprises fluorine gas and nitrogen, argon or helium as a dilution gas.

21. The method for preparing the polymer gas separation membrane according to claim 19, wherein the direct fluorination is conducted for 1 minute to 24 hours.
